(19) United States
(12) Patent Application Publication
(10) Pub. No.: US 2011/0219923 A1
(43) Pub. Date: Sep. 15, 2011

(54) Gathering method and apparatus for a keypad fabrication process

(76) Inventors: Chiu-Yu Yeh, Taoyuan (TW); Wei-Liang Lin, Taoyuan (TW); Chia-Sheng Cheng, Taoyuan (TW)

(21) Appl. No.: 12/813,496

(22) Filed: Jun. 10, 2010

(30) Foreign Application Priority Data
Mar. 15, 2010 (TW) 099107461

(51) Int. Cl. B26D 7/27; B26D 7/06; B26D 7/18

(52) U.S. Cl. 83/23; 83/50; 83/167; 83/111

(57) ABSTRACT

A gathering method for a keypad fabrication process, in which a key-top tree is placed into a punching die, the punching die is aligned, a receiving device is disposed under the punching die, an assembly jig is disposed on the receiving device and aligned using an x-y table for gathering a punched-out key-top, a punch disposed above the punching die using another x-y table for allowing the punching die to perform both punching the key-top tree and gathering the punched-out part onto the assembly jig. Each key-top on the key-top tree is punched out and gathered on the assembly jig by repeating the aforementioned steps. Accordingly, the key-tops can be punched out and arranged on the assembly jig with a different pitch from the key-top tree automatically, fast and correctly. A gathering apparatus for a keypad fabrication process is also provided.

### BACKGROUND OF THE INVENTION

1. Field of the Invention

The present invention relates to a keypad fabrication process and an apparatus for a keypad fabrication process, and particularly to a gathering method and an apparatus for a keypad fabrication process.

2. Description of the Prior Art

The technology for keypad structures of portable electric products such as mobile phones, PDA, electric dictionaries, remote controllers, in-house telephones, calculators, and the like is increasingly developed. Among these developments, keypad primary pieces are formed through the combination of the plastic material and the rubber material. As shown in FIG. 1, the combination of the plastic material and the rubber material is mostly accomplished as follows. A plastic injection molding is carried out to form a key-top tree 12 (a tree-like work piece) including a plurality of thin key-tops 10. The key-tops 10 are printed to have symbols or figures on each key surface. The key-tops are punched off the key-top tree and transferred manually or by a tool onto an assembly jig, as shown in FIG. 2, to be combined with the rubber film 14 to form the keypad primary piece 16.

In consideration of die approach design and punch process, plastic material is subjected to injection-molding to form a key-top tree with key-tops 10 having a distance P₁ between each other, as shown in FIG. 1. The key-tops in the key-top tree can not be as close as keys of a keypad product shown in FIG. 2, in which the key-tops 10 have a distance P₂ between each other. That is, P₁ and P₂ are different . Conventionally, one process is to make key-tops in different key-top trees from different injection molds respectively, and the key-tops are printed and punched to become discrete singular key-tops to be stored. Then, a set of key-tops are sorted manually and moved to an assembly jig in positions to combine to a rubber film in a film jig through an adhesive. The assembly jig and the film jig are clamped and pressed together to form a keypad primary piece after dryness. Such sorting and allotment take effort and time, and “misplaced” situation often takes place. It is not efficient. Therefore, it is understood that the difference of P₁ from P₂ brings subsequent assembly process trouble, and automation level is affected.

TWM 365536 discloses a keypad assembly device of keypad primary pieces after multiple punching processes, in which multiple key-top trees are utilized. A set of key-tops needed for a keypad product are obtained from a plurality of key-top trees, a group of the key-tops in each key-top tree. Thus, the key-tops located in one key-top tree can gain a sufficient space and be arranged in positions corresponding to those for a product. When each key-top in the key-top trees is punched off, it can be placed onto the assembly jig. The assembly jig is not moved between any two punches until a whole set of key-tops are arranged. Thereafter, the assembly jig is stacked with a glide plate of a delivering mechanism and moved to be under a press tool of a press mechanism to combine with a rubber conductive film.

However, there is still a need for a novel fabrication process and apparatus to more efficiently make the keys.

### SUMMARY OF THE INVENTION

An objective of the present invention is to provide a gathering method for a keypad fabrication process and a key-top gathering apparatus therefor. The punching step and the arrangement for the key-tops are accomplished at one go by machine. Accordingly, the aforesaid problem caused by the difference of the distance P₁ from the distance P₂ can be resolved, such that the subsequent assembly is easy and can be highly automatized, giving an improved efficiency.

The gathering method for a keypad fabrication process according to the present invention includes steps as follows. First, a key-top tree is provided. The key-top tree includes a plurality of key-tops connecting to each other. The key-top tree is placed into a punching die. A receiving device is placed under the punching die. The receiving device comprises an assembly jig for gathering a punched-out key-top from the punching die. A punch is placed above the punching die for allowing the punching die to punch the key-top tree. Thereafter, a first punching process is performed on a first key-top of the key-tops. The first punching process comprises steps as follows. The receiving device is shifted using a first x-y table to prepare the receiving device for receiving the first key-top onto the assembly jig in a first position. The punch is shifted using a second x-y table to a second position, such that the first position, the first key-top of the key-top tree, and the second position are aligned. Thereafter, the first key-top is punched out and gathered on the assembly jig in the first position. Thereafter, a second punching process is performed on a second key-top of the key-tops. The second punching process includes steps as follows. The receiving device is shifted using the first x-y table to prepare the receiving device for receiving the second key-top onto the assembly jig in a third position. The punch is shifted using the second x-y table to a fourth position, such that the third position, the second key-top of the key-top tree, and the fourth position are aligned. Thereafter, the second key-top is punched out and gathered on the assembly jig in the third position.

The key-top gathering apparatus for a keypad fabrication process according to the present invention mainly includes a punching die, a receiving device, a first x-y table, an assembly jig, a punch and a second x-y table. The punching die includes a top die, a cutting die, a plurality of first springs, a plurality of strike pins and a plurality of punching pins. The top die includes a plurality of first holes. The cutting die is disposed under the top die and includes a plurality of second hole correspondingly to the first holes of the top die respectively. Each first spring has a lower portion inset within the first hole of the top die to be fixed on the top die. Each strike pin is disposed on the first springs and extends downwardly to pass through the first hole of the top die. Each punching pin combines with the lower end of each strike pin. The receiving device is disposed under the punching die. The first x-y table is for shifting the receiving device to a place. The assembly jig is disposed on the receiving device for receiving punched-out key-tops. The punch is disposed above the punching die. The second x-y table is for shifting the punch to be above a selected one of the strike pins for hitting the selected strike pin.

In the present invention, desired key positions (i.e. predetermined key positions) and key-top positions of a key-top tree can be set respectively for example in a computer system to control two x-y tables to move the punch and the receiving device to predetermined positions, respectively. The predetermined positions for the punch correspond to key-tops of the key-top tree, and the predetermined positions of the receiving device correspond to predetermined key positions in the product. The punch is performed when the punch, the key-top of the key-top tree to be punched, and the position on the receiving device to receive the key-top are aligned, and the punched-off key-top directly goes down to the assembly jig on the receiving device and is well arranged in a predetermined position. Thus, using the method and the apparatus of the present invention to punch key-tops in the order and to gather them on the assembly jig in predetermined positions, the key-tops are well arranged on the assembly jig immediately after the key-tops are punched off the key-top tree. The assembly jig with a set of well arranged key-tops can be provided for an adhesion process to adhere to a film to accomplish an assembly of a keypad primary piece. In the present invention, since it does not need to manually pick up separate key-tops for the subsequent process, the fabrication of keypad can be fast and correct.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic perspective view illustrating a conventional key-top tree;

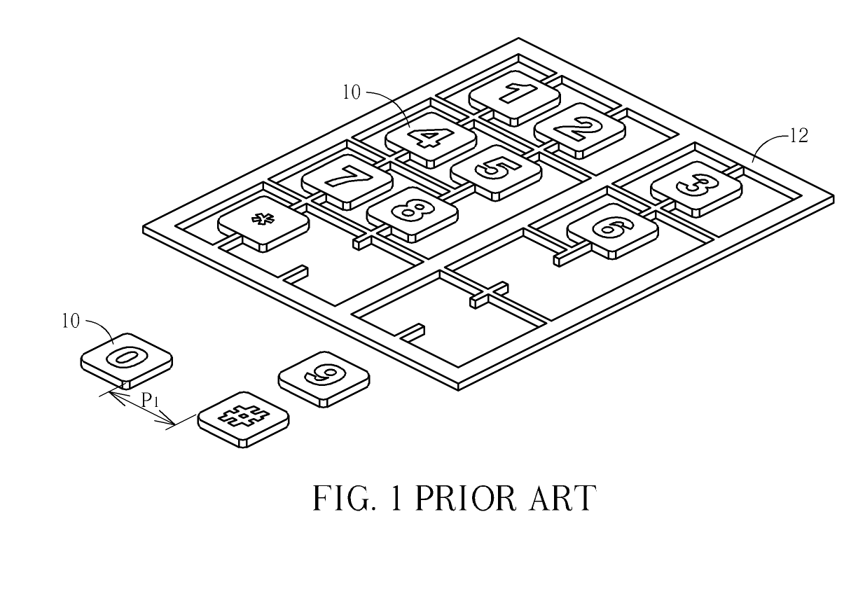

FIG. 2 is a schematic perspective view illustrating a conventional keypad primary piece;

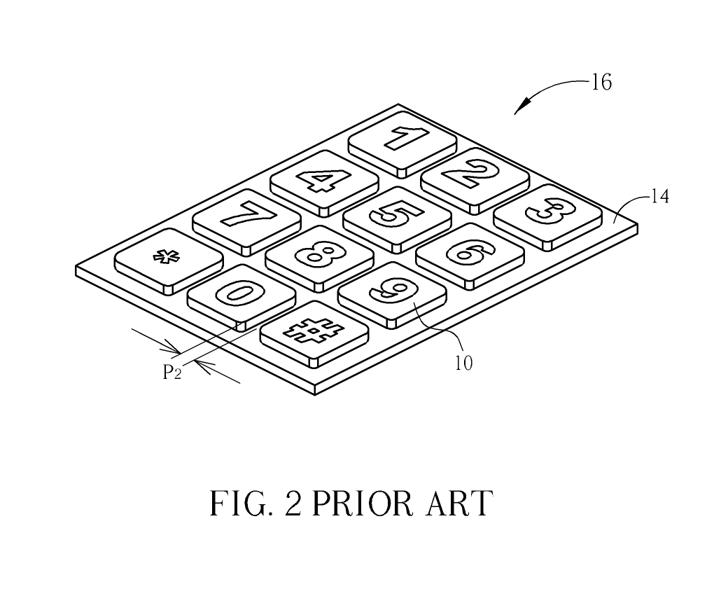

FIG. 3 is a flow chart illustrating an embodiment of the gathering method for a keypad fabrication process according to the present invention;

FIG. 4 is a flow chart illustrating completely punching out and arranging a set of key-tops utilizing the gathering method according to the present invention;

FIG. 5 is a schematic side view illustrating a key-top gathering apparatus for a keypad fabrication process according to the present invention;

FIG. 6 is a schematic perspective exploded view illustrating a key-top gathering apparatus for a keypad fabrication process according to the present invention;

FIG. 7 is a schematic cross-section view illustrating the key-top gathering apparatus as shown in FIG. 6;

FIG. 8 is a schematic cross-section view illustrating another embodiment of the key-top gathering apparatus according to the present invention;

FIG. 9 is a schematic cross-section view illustrating further another embodiment of the key-top gathering apparatus according to the present invention;

FIG. 10 is a schematic cross-section view illustrating still another embodiment of the key-top gathering apparatus according to the present invention;

FIG. 11 is a schematic cross-section view illustrating a closing situation of the key-top gathering apparatus as shown in FIG. 10;

FIG. 12 is a schematic cross-section view illustrating an embodiment of an assembly jig utilized in the key-top gathering apparatus according to the present invention; and

FIG. 13 is a schematic cross-section view illustrating another embodiment of an assembly jig utilized in the key-top gathering apparatus according to the present invention.

### DETAILED DESCRIPTION

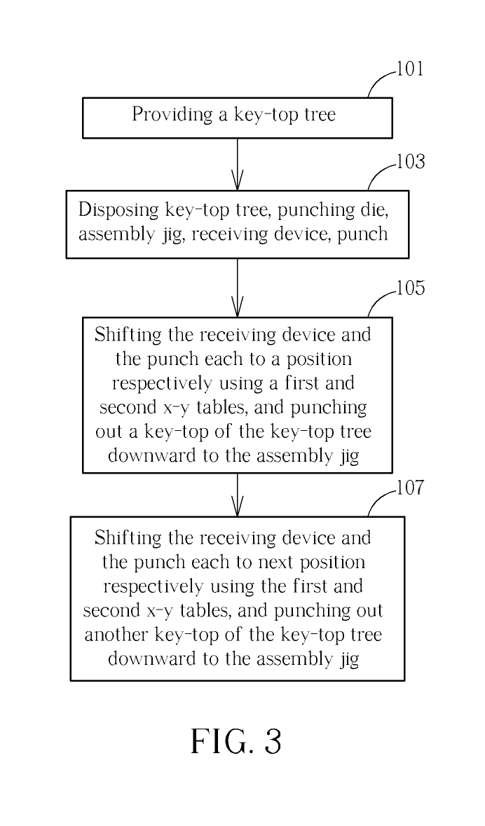

FIG. 3 is a flow chart illustrating an embodiment of the gathering method for a keypad fabrication process according to the present invention. First, a step 101 is performed to provide a key-top tree. The key-top tree includes a plurality of key-tops connecting to each other. A step 103 is carried out to place the key-top tree into a punching die. The punching die may be further doweled. A receiving device is placed under the punching die. The receiving device comprises an assembly jig for gathering a punched-out key-top from the punching die. A punch is placed above the punching die for allowing the punching die to punch the key-top tree. Thereafter, a step 105 is carried out to punch a key-top off the key-top tree. The punched-off key-top is pushed downward directly to be arranged onto the assembly jig on the receiving device, i.e. being “punched-off and arranged” on the assembly jig. Thereafter, a step 107 is carried out similarly to the step 105 to punch another key-top off the key-top tree. The another punched-off key-top is pushed downward directly to be arranged onto the assembly jig on the receiving device, i.e. being “punched-off and arranged” on the assembly jig. Other punched-off key-tops are also gathered in the same way.

In detail, with respect to the step 105, a first punching process is performed on the first key-top. The first punching process includes steps as follows. The receiving device is shifted (or moved) using a first x-y table to a predetermined position and prepared for receiving the first punched-off key-top onto the assembly jig in a first position. The first x-y table moves in accordance with a plurality of key positions of a designed keypad primary piece (i.e. the keypad primary piece of a desired keypad product). Therefore, the first position is an actual position for the first key-top to be located in the keypad product. The punch is shifted using a second x-y table to a second position. The second x-y table moves in accordance with the positions of key-tops of the key-top tree. Therefore, the punch is shifted to be above the first key-top which is going to be punched. In this way, the first position, the first key-top of the key-top tree, and the second position are aligned. Thereafter, the punch hits downward to allow the first key-top to be punched out by the punching die, and the first key-top is impacted to go downward and be arranged on a first position on the assembly jig, i.e. gathered on the assembly jig. The punch goes up to the original place after hitting and gathering the first key-top.

With respect to the step 107, a second punching process is performed on the second key-top similar to the step 105. The second punching process includes steps as follows. The receiving device is shifted using a first x-y table to prepare for receiving the second punched-off key-top onto a third position. The second x-y table moves the punch to a fourth position, that is, the punch is shifted to be above the second key-top which is going to be punched. In this way, the third position, the second key-top of the key-top tree, and the fourth position are aligned. Thereafter, the punch hits downward to allow the second key-top to be punched out and gathered on the assembly jig in the third position. Thereafter, the punch goes up back to the original place after the hitting.

In the method of the present invention, the key-tops distributed in a desired keypad primary piece with a distance from each other, which is different from the distance with which from each other the key-tops are distributed in the key-top tree. The key-tops distributed in the desired keypad primary piece may be in a closer way, and these can be the desired features of embodiments of the present invention. Accordingly, in view of the above embodiment, the distance between the second position and the fourth position can be less than the distance between the first position and the third position. Accordingly, the method according to the present invention can be utilized to directly punch out key-tops which are distributed less dense in a key-top tree, to allow the key-tops to directly reach on the assembly jig in an actually desired position as in a keypad primary piece, for a subsequent adhesion process to conveniently combine with films to form the keypad primary piece. Material for key-top tree is not particularly limited. Conventionally, the key-top tree is often made of plastic molded articles, which can be utilized in the present invention. The film may be often a rubber film or silicon rubber film.

All key-tops of a key-top tree may be punched and arranged on an assembly jig, becoming a set of key-tops, using the aforesaid process. The assembly jig with a set of key-top gathered thereon may be delivered to an adhesion tool for combination with other member. For example, the key-tops gathered on the assembly jig may be combined with a film through an adhesive layer, in situ on the assembly jig, to form a keypad primary piece. Thus, after punched, the key-top may have a front surface facing the assembly jig as desired, but it is not limited thereto. The “front surface” of a key-pad is a surface with figure or figures which serve as the figures on a keypad of a product being seen by users.

In an embodiment of the present invention, a key-top with a defect (or flaw) may be not punched. Since in the present invention, the receiving device and the punch are shifted by two x-y tables respectively, the movement of the x-y tables may be controlled by a computer system. When the key-top of the key-top tree has a defect, it can be skipped, so as not to be subjected to the punching process easily with the computer system. Herein, it may be referred as “skip punching”. When operation workers observe a defect or defects on one or more key-tops in a provided key-top tree, the “skip punching” can be set up for that or those key-tops by a computer program, before a punching process starts. Accordingly, products with defects (or flaws) can be decreased.

Furthermore, after it is finished punching and gathering the key-tops of the key-top tree, the key-top tree is replaced with another key-top tree to perform the punching and gathering process. The latter key-top tree includes a key-top without a defect for filling the vacancy of the omitted key-top to form a whole set of the key-tops on the assembly jig.

Furthermore, the place on the assembly jig to receive each punched-out key-top has a shape of dish. The dish bottom has a hole for fixing the key-top by, for example, suction through a vacuum pipe connecting to a vacuum equipment.

Alternatively, the assembly jig may include a temporary adhering layer, and each punched-out key-top is punched out to directly go down to the temporary adhering layer and temporarily adheres to the temporary adhering layer. Herein, “temporary adhering” means there is adhesion strength between an adhered article (i.e. a key-top in the present invention) and an adhering article and these two articles can be easily taken apart by a force, and they are preferably completely apart, i.e. it is preferred to allow the key-top not to be clung by material of the temporary adhering layer. Adhesive dusting paper may be one of those suitable as the temporary adhering layer.

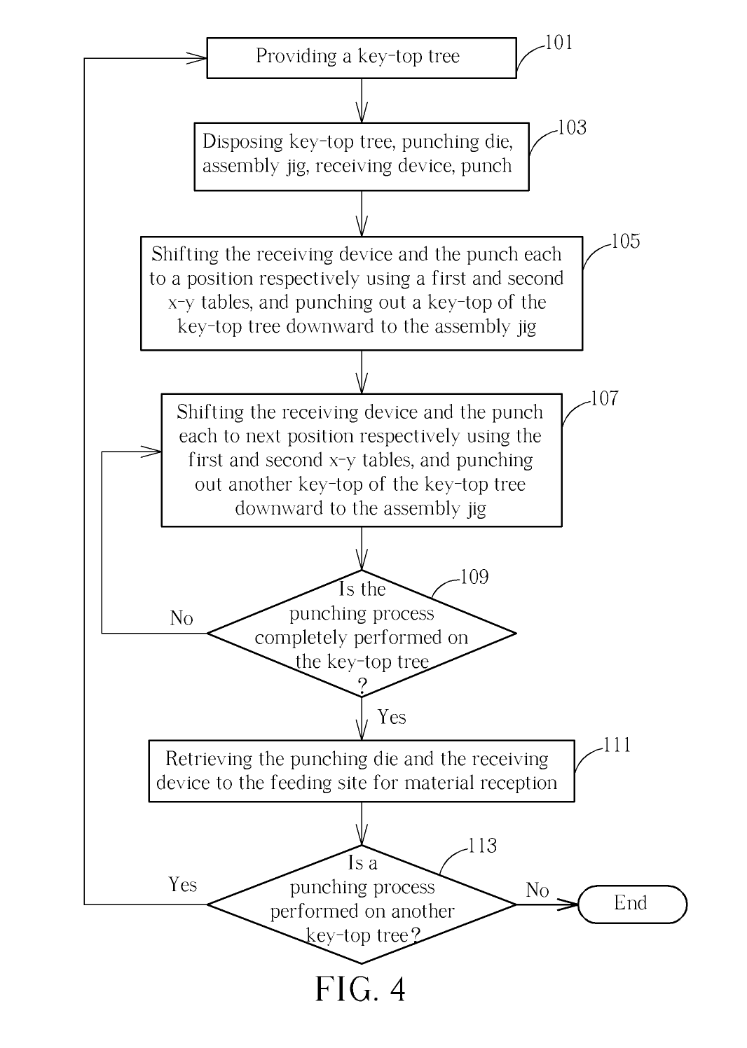

FIG. 4 is a flow chart illustrating completely punching out and arranging a set of key-tops utilizing the gathering method according to the present invention. A step 109 maybe performed after the step 107 is performed, to inspect whether if the punching and arranging process is completed. If it is not completed, the step 107 may be repeated to punch a key-top, and if it is completed, a step 111 may be performed to return the punching die and the receiving device to the loading location for unloading, to deliver the assembly jig on the receiving device to an adhesive tool for adhesion process, and to take out the remaining key-top tree in the punching die. A step 113 may be further performed to judge whether if another key-top tree is needed for the punching. If “yes”, the step 101 is performed to provide another key-top tree for punching and arrangement. If “no”, the process flow ends. Therefore, using the method of the present invention may lead to a facile automation.

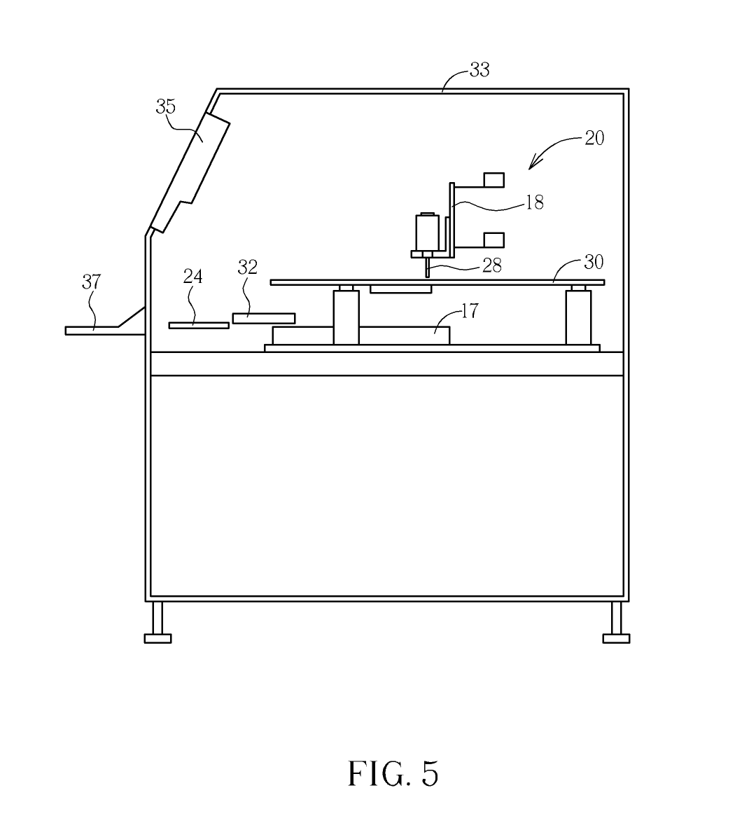

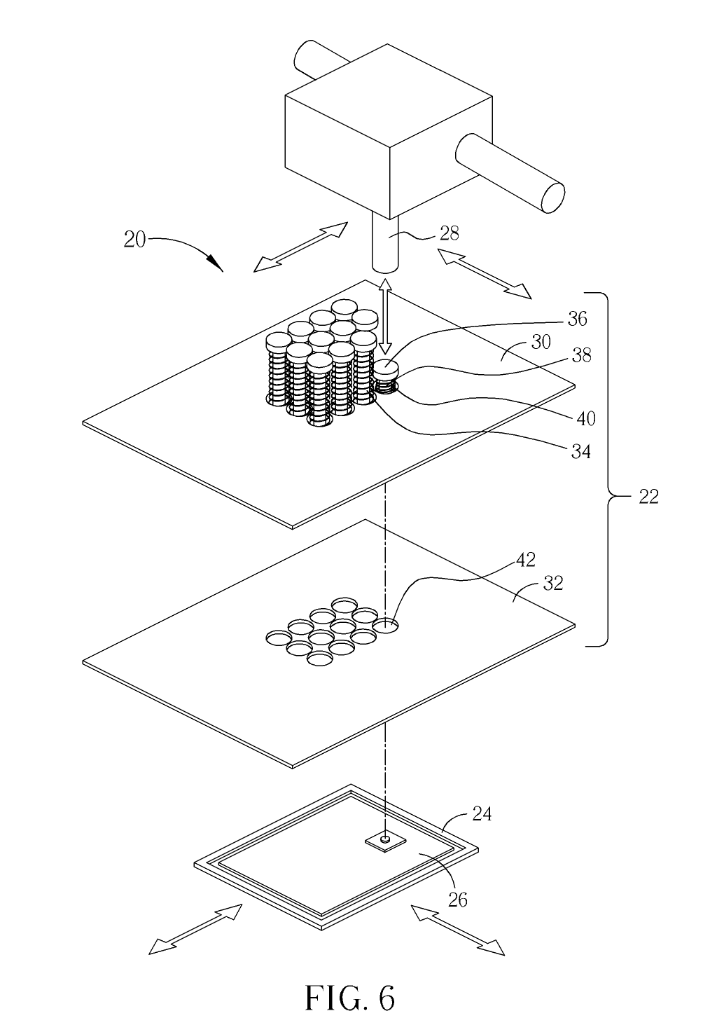

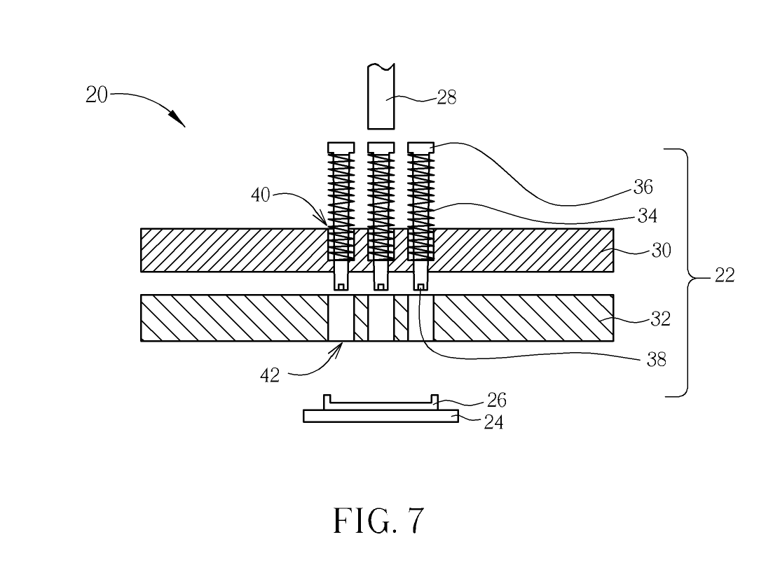

FIG. 5 is a schematic side view illustrating a key-top gathering apparatus for a keypad fabrication process, FIG. 6 is a schematic perspective exploded view illustrating a key-top gathering apparatus for a keypad fabrication process, and FIG. 7 is a schematic cross-section view illustrating the key-top. The key-top gathering apparatus 20 mainly includes a punching die 22, a receiving device 24, an assembly jig 26, and a punch 28. The punching die 22 includes a top die 30, a cutting die 32, a plurality of first springs 34, a plurality of strike pins 36 and a plurality of punching pins 38. The top die 30 includes a plurality of first holes 40. The cutting die 32 is disposed under the top die 30 and includes a plurality of second holes 42 correspondingly to the first holes 40 of the top die 30 to form a through hole respectively. The position and the size of the through hole are corresponding to the key-tops of the key-top tree to be punched. When the punching is performed, the key-top tree is placed on the cutting die 32. Each key-top is corresponding to a second hole 42. The side of the hole 42 is a cutting edge for cutting the key-top off the key-top tree. Each first spring 34 has a lower portion inset within the first hole 40 of the top die 30, and accordingly it is fixed on the top die 30. Each strike pin 36 is disposed on the first spring 34 and extends downwardly to pass through the first hole 40 of the top die 30. Each punching pin 38 combines with the lower end of each strike pin 36. The receiving device 24 is disposed under the punching die 22 and placed on an x-y table 17 as shown in FIG. 5. The x-y table 17 can shift the receiving device 24 to a desired place. The assembly jig 26 is disposed on the receiving device 24 for receiving punched-out key-tops. The punch 28 is disposed above the punching die 22 and may be combined with an x-y table 18 for example as shown in FIG. 5. The x-y table 18 can shift the punch 28 to be above a selected strike pin 36 for hitting the strike pin 36. FIG. 5 further shows a housing 33 and a loading/unloading platform 37. The housing 33 is for accommodating the key-top gathering apparatus 20, and may have a transparent window 35 for workers to inspect the operation of the apparatus.

In the present invention, the receiving device 24 is oriented by a first x-y table. The first x-y table moves in accordance with a plurality of key positions of a designed keypad primary piece. The punch 28 is oriented by a second x-y table. The second x-y table moves in accordance with positions of a plurality of key-tops of a key-top tree. When the punch 28 is hitting, the punch 28, a key-top of a plurality of key-tops of the key-top tree (i.e. the target to be punched out), and the receiving device 24 are aligned in position.

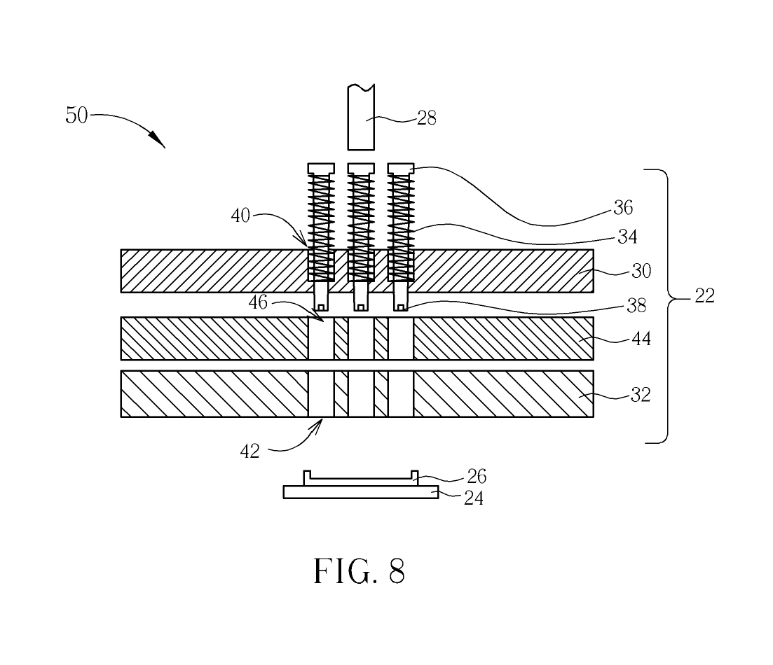

In the embodiment as shown in FIG. 8, the key-top gathering apparatus 50 may further include a guide plate 44 disposed between the top die 30 and the cutting die 32. The guide plate 44 includes a plurality of third holes 46 connected to the first holes 40 and the second holes 42 of the top die 30 and the cutting die 32 for increasing impact displacement distance of the punching pins 38.

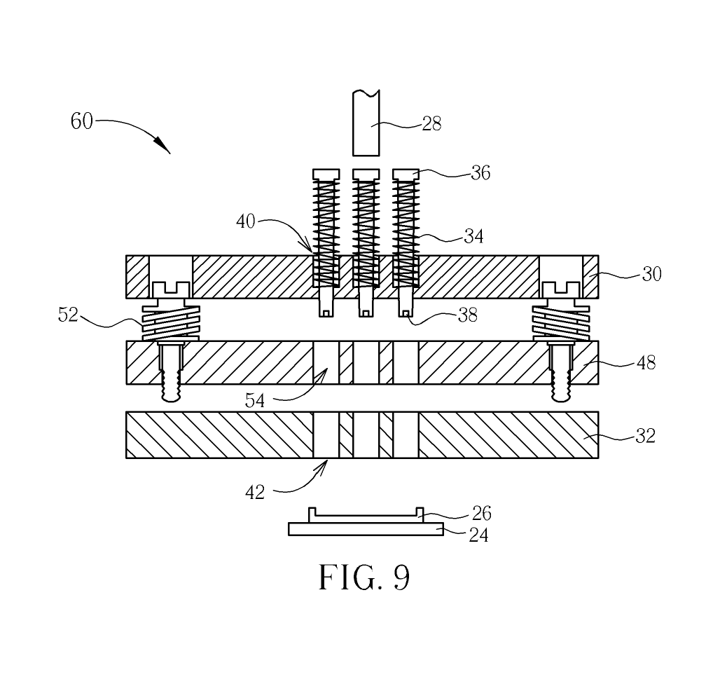

In the embodiment as shown in FIG. 9, the key-top gathering apparatus 60 may further include a stripper 48 disposed between the top die 30 and the cutting die 32. At least a spring device 52 (including for example springs) disposed between the stripper 48 and the top die 30. The stripper 48 includes a plurality of fourth holes 54 connected to the first holes 40, the second holes 42 of the top die 30 and the cutting die 32. The stripper 48 is for stripping the key-top tree down off the punching pin 38 by virtue of the bounce provided by the spring device 52 after performing the punching process.

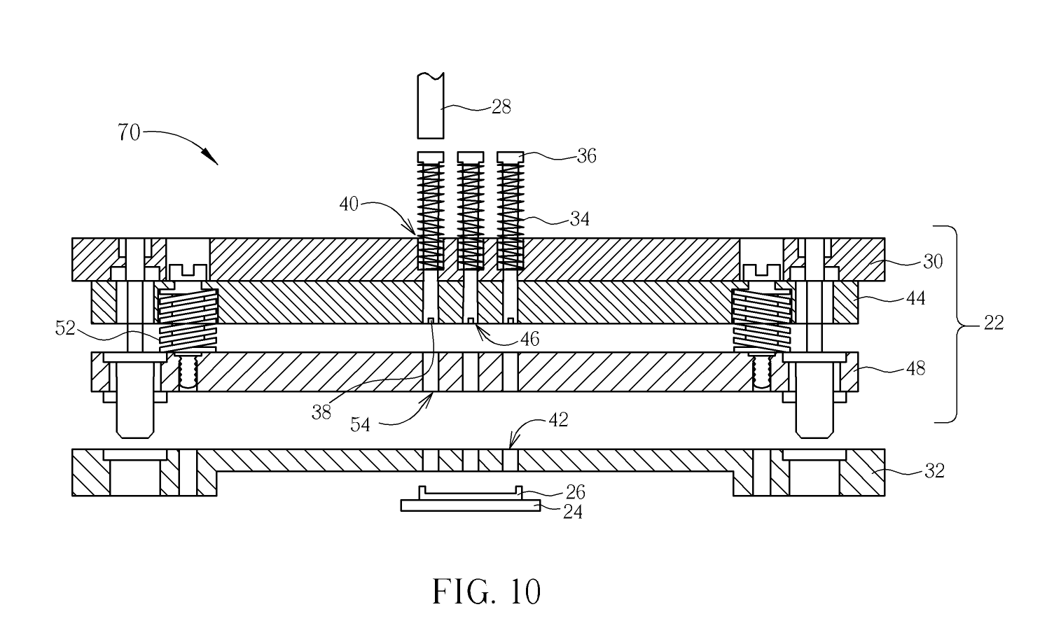

In the embodiment as shown in FIG. 10, the key-top gathering apparatus 70 may further include a guide plate 44 and a stripper 48. The guide plate 44 is disposed under the top die 30. The stripper 48 is disposed between the guide plate 44 and the cutting die 32. The spring device 52 is disposed between the stripper 48 and the guide plate 44. The first holes 40, the third holes 46, the fourth holes 54 and the second holes 42 are connected correspondingly.

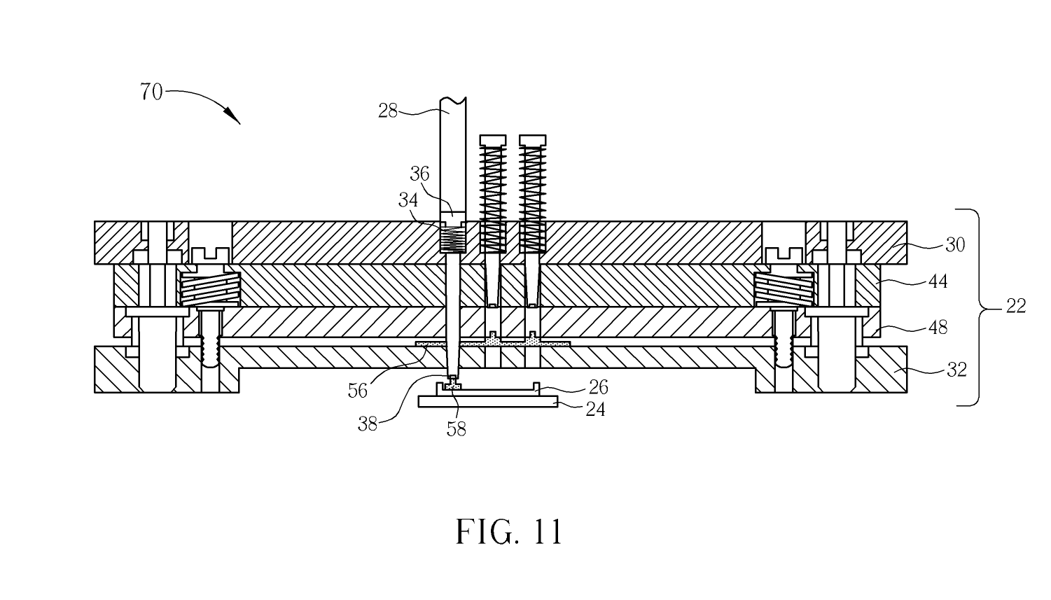

FIG. 11 shows a closing situation of the key-top gathering apparatus 70 as shown in FIG. 10 to punch a key-top tree 56. After the key-top tree 56 is placed within the cutting die 32 in the punching die 22, the cutting die 32, the top die 30, the guide plate 44, and the stripper 48 are closed together to allow the punching die 22 to be ready for punching. A receiving device 24 is placed under the punching die 22. The receiving device 24 includes an assembly jig 26 for gathering a punched-out key-top. The punch 28 is allowed to hit downward on the strike pin 36, and press down the spring 34. Accordingly, the strike pin 36 continue going downward to passing the hole to allow the punching pin 38 to hit the key-top 58. The key-top 58 is cut through the cutting die 32 and pushed down to be arranged on a position of the assembly jig 26. The punch 28 comes back to the original position after the hitting. When the punch 28 goes back upward, the punching pin 38 also goes back upward to the original position. The stripper 48 removes the key-top tree which may be stuck to the punching pin 38. The punch 28 goes back to the place the same as that before the hitting, and then moves to another place above next key-top. The receiving device also moves to next position, for allowing the assembly jig to move to the position for receiving next key-top in next punching process. As one feature of the present invention, during the punching and arrangement process for one set of key-tops, only the punch 28 and the receiving device 24 (including the assembly jig 26 thereon) are shifted horizontally, and the punching die 22 is fixed and not moved, except that the spring 34, the strike pin 36, and the punching pin 38 goes down and up for hitting, and the stripper 48 goes down and up for remove the key-top trees.

Furthermore, the movement of the aforesaid parts may be controlled by a computer system. Particularly, each key-top may be numbered and the numbers can be shown on the monitor. Operation workers may select or click a desired number of the key-top for selectively carrying out the punching.

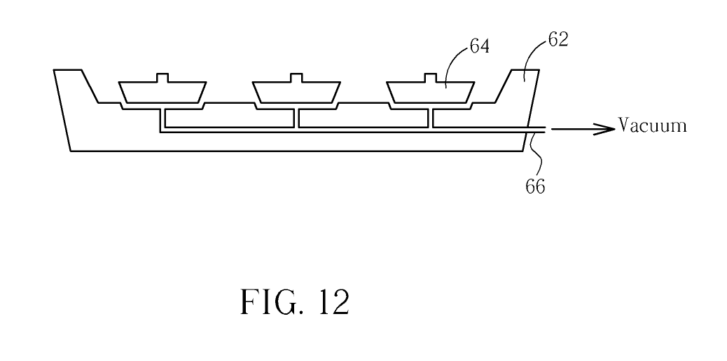

Furthermore, as shown in FIG. 12, the place on the assembly jig 62 to receive each punched-out key-top 4 has a shape of dish. The dish bottom has a hole for fixing the key-top 64 by for example suction through a vacuum pipe 66 connecting to a vacuum equipment, allowing the key-top 64 to not move or shake during the fabrication process.

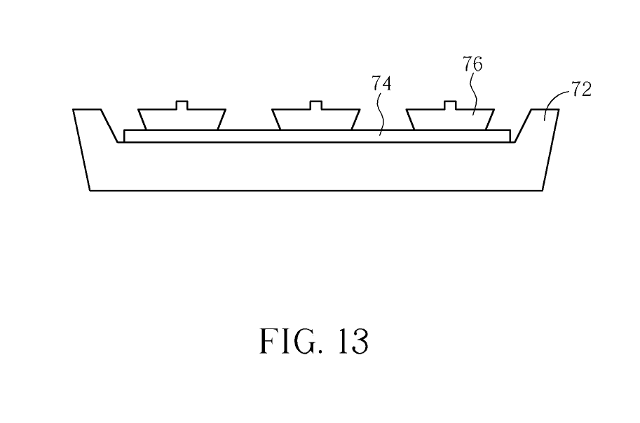

Alternatively, as shown in FIG. 13, the assembly jig 72 may include a temporarily adhering layer 74. Each punched-out key-top 76 is punched out to directly go down to the temporary adhering layer 74 and temporarily adheres to the temporary adhering layer 74.

The movement of the aforesaid parts, such as receiving device, punch, x-y tables and the like, may be accomplished by mechanism using oil pressure, robot, slide, lead screw, or the like.

Those skilled in the art will readily observe that numerous modifications and alterations of the device and method may be made while retaining the teachings of the invention.

What is claimed is:

1. A gathering method for a keypad fabrication process, comprising:
providing a key-top tree comprising a plurality of key-tops connecting to each other;
placing the key-top tree into a punching die;
placing a receiving device under the punching die, the receiving device comprising an assembly jig for gathering a punched-out key-top from the punching die;
placing a punch above the punching die for allowing the punching die to punch the key-top tree;
performing a first punching process on a first key-top of the key-tops, wherein the first punching process comprises:
shifting the receiving device using a first x-y table to prepare the receiving device for receiving the first key-top onto the assembly jig in a first position, shifting the punch using a second x-y table to a second position such that the first position, the first key-top of the key-top tree, and the second position are aligned, and punching out and gathering the first key-top on the assembly jig in the first position; and
performing a second punching process on a second key-top of the key-tops, wherein the second punching process comprises:
shifting the receiving device using the first x-y table to prepare the receiving device for receiving the second key-top onto the assembly jig in a third position, shifting the punch using the second x-y table to a fourth position such that the third position, the second key-top of the key-top tree, and the fourth position are aligned, and punching out and gathering the second key-top on the assembly jig in the third position.

2. The method according to claim 1, wherein, the key-tops gathered on the assembly jig have a first distance from each other, the key-tops of the key-top tree have a second distance from each other, and the first distance is different from the second distance.

3. The method according to claim 1, wherein, the key-tops gathered on the assembly jig have a first distance from each other, the key-tops of the key-top tree have a second distance from each other, and the first distance is less than the second distance.

4. The method according to claim 1, wherein, a distance from the second position to the fourth position is less than a distance from the first position to the third position.

5. The method according to claim 1, wherein all of the key-tops of the key-top tree are punched out respectively and gathered on the assembly jig.

6. The method according to claim 5, further comprising:
a step of combining each of the key-tops gathered on the assembly jig with a film to form a keypad primary piece, wherein the step is carried out in situ on the assembly jig.

7. The method according to claim 5, wherein, one of the key-tops of the key-top tree, which has a defect, is left on the key-top tree and not subjected to the punching process.

8. The method according to claim 7, wherein after finishing punching and gathering the key-tops of the key-top tree, the key-top tree is replaced with another key-top tree having a same key-top without a defect to complete a whole set of the key-tops on the assembly jig for forming a keypad primary piece.

9. The method according to claim 1, wherein the place on the assembly jig to receive each punched-out key-top has a shape of dish, and the dish bottom has a hole for fixing the key-top by suction.

10. The method according to claim 1, wherein, the assembly jig comprises a temporary adhering layer, and each punched-out key-top is punched out to directly go down to the temporary adhering layer and temporarily adheres to the temporary adhering layer.

11. A key-top gathering apparatus for a keypad fabrication process, comprising:
a punching die comprising:
a top die comprising a plurality of first holes, a cutting die disposed under the top die and comprising a plurality of second hole correspondingly to the first holes of the top die respectively,
a plurality of first springs each having a lower portion inset within the first holes of the top die to be fixed on the top die respectively, a plurality of strike pins disposed on the first springs and extending downwardly to pass through the first holes of the top die respectively, and
a plurality of punching pins combined with the lower ends of the strike pins respectively;
a receiving device disposed under the punching die;
a first x-y table for shifting the receiving device to a place;
an assembly jig disposed on the receiving device for receiving punched-out key-tops;
a punch disposed above the punching die; and
a second x-y table for shifting the punch to be above a selected one of the strike pins for hitting the strike pin.

12. The device according to claim 11, wherein when the punch is hitting the strike pin, the punch, one of the key-tops of the key-top tree, and the receiving device are aligned.

13. The device according to claim 11, further comprising a guide plate disposed between the top die and the cutting die, wherein the guide plate comprises a plurality of third holes connected to the first holes and the second holes for increasing impact displacement distance of the punching pins.

14. The device according to claim 13, further comprising a stripper disposed between the guide plate and the cutting die, and at least a spring device disposed between the stripper and the guide plate, the stripper comprises a plurality of fourth holes connected to the first holes, the second holes, and the third holes, for stripping the key-top tree off the punching pin by the at least a spring device after performing the punching process.

15. The device according to claim 11, further comprising a stripper disposed between the top die and the cutting die, and at least a spring device disposed between the stripper and the top die, the stripper comprises a plurality of fourth holes connected to the first holes and the second holes, for stripping the key-top tree off the punching pin by the at least a spring device after performing the punching process.

16. The device according to claim 11, wherein the place on the assembly jig to receive each punched-out key-top has a shape of dish, and the dish bottom has a hole for fixing the key-top by suction.

17. The device according to claim 11, wherein the assembly jig comprises a temporary adhering layer, and each punched-out key-top is punched out to directly go down to the temporary adhering layer and temporarily adheres to the temporary adhering layer.
